(19) United States
(12) Patent Application Publication
(10) Pub. No.: US 2026/0199849 A1
(43) Pub. Date: Jul. 16, 2026

(54) AGITATOR AND AGITATION METHOD

(71) Applicant: IBARAKI UNIVERSITY, Mito-shi, Ibaraki (JP)

(72) Inventor: Kaoru UESUGI, Hitachi-shi (JP)

(73) Assignee: IBARAKI UNIVERSITY, Mito-shi, Ibaraki (JP)

(21) Appl. No.: 19/134,322

(22) PCT Filed: Nov. 15, 2023
(86) PCT No.: PCT/JP2023/041158

§ 371 Date: May 30, 2025

(30) Foreign Application Priority Data
Dec. 1, 2022 (JP) 2022-193176

(51) Int. Cl. B01F 31/20; B01F 35/32; B01F 101/44

(52) U.S. Cl. CPC B01F 31/20; B01F 35/325; B01F 2101/44

(57) ABSTRACT

The agitator has a support unit that supports a container, a striking unit that strikes the container, and a drive unit 4 that drives the striking unit. The container is accommodated within a mixed object to be agitated and is supported by the support unit. The striking unit is driven by the drive unit to strike the container continuously at predetermined intervals. This agitates the mixed object accommodated in the container.

### TECHNICAL FIELD

A present invention relates to an agitator and an agitation method.

### BACKGROUND ART

A method of forcibly mixing and agitating two different types of contents without using agitation blades provided in a container has been known for liquid-like mixing and agitation (Patent Literature 1). In a mixing and agitation device, the container having cylindrical shape is placed on a rotating base and rotated around an axial direction of the cylindrical shape to generate a forced vortex in the container. Then, the forced vortex is collapsed by Coriolis action due to the rotation of the container around a direction orthogonal to the axial direction, and the contents are evenly mixed together. A liquid can be mixed without the use of agitator blades by using the collapsing action of the forced vortex to agitate the container.

In other agitation device, an agitator consisting of a permanent magnet is placed in a test tube, and a motor rotates the permanent magnet in close to the test tube to synchronize the agitator with a rotating magnetic field of the permanent magnet, thereby agitating liquid in the test tube (Patent Literature 2). Also, a guide shaft is inserted into the test tube to guide the agitator made of the permanent magnet in an axial direction, and a stator coil around the test tube is moved in the axial direction to move the agitator and agitate the liquid.

The agitation device is used in the preparation of lipid unicellular membrane vesicles, lipid bimolecular membrane vesicles (liposomes, vesicles), colloids, and droplets in the fields of medicine, pharmaceuticals, cosmetics, food, cell culture, chemical systems, and molecular robotics. To produce these materials, a preparer holds a one end portion 12 of a container 10 with one hand and tapping an other end portion 13 of the container 10 with the other finger as shown in FIG. 29.

### CITATION LIST

### Patent Literature

Patent Literature 1 Japanese Utility Model Registration No. 3190993

Patent Literature 2 Japanese Utility Model Application Publication No. S60-100026

### SUMMARY OF INVENTION

### Technical Problem

However, the agitation device based on the collapse of forced vortex by the action of Coriolis described in Patent Literature 1 fails to provide sufficient mixing effect in the preparation of lipid unicellular membrane vesicles, lipid bimolecular membrane vesicles (liposomes, vesicles), colloids, and droplets. The agitation device described in the Patent Literature 2 is difficult to apply to the fields of medicine, pharmaceuticals, cosmetics, etc., because the agitator is inserted into the liquid to be agitated. Although agitators such as vortex mixers, which are generally available on the market, agitate by applying vibration to the container, they are not suitable for agitating fine particles (bubbles) in the liquid, or for generating oil droplets or vesicles.

Although, the preparer provides an impact to the container with his/her hands or fingers to agitate in the tapping process, there are individual differences in the vibration or applied impact, resulting in low yields due to variations in the size of lipid unicellular membrane vesicles, lipid bimolecular membrane vesicles (liposomes, vesicles), colloids, and droplets. Thus, a strong demand for improvement was occurred from the field. The preparer made a cell distribution in the suspension so as to uniform by manually vibrating or shocking the suspension just before cell seeding in the field of cell culture (especially in regenerative medicine), which causes the variability by the preparer. Since iPS cells may be damaged by shocks applied thereto, there was a need to develop a new device to adjust the degree of shocks and vibrations and set certain conditions. If cells regardless of the iPS cells are not effectively suspended and agitated, agglomerates of cells may occur at the time of seeding cells on the culture surface. Furthermore, when the preparer impacts the container by moving the same back and forth over the mesh multiple times as a scrabbing by hand, the above problems occur.

Therefore, the purpose of the present invention is to provide an agitator and an agitation method capable of agitating etc. by striking a container under certain conditions.

### Solution to Problem

To solve the above problems, a first invention provides an agitator including a support unit supporting a container with a mixed object, a striking unit that continuously strikes the container, and a driving unit that drives the striking unit.

A second invention is the agitator according to the first invention, wherein the container has a one end portion and an other end portion opposite the one end portion, wherein the support unit supports the one end portion of the container, and wherein the striking unit strikes the other end portion of the container.

A third invention is the agitator according to any of the first to fourth inventions, wherein the support unit movably and detachably supports the container, wherein the agitator further includes an adjusting unit that adjusts a position of the support unit, and restoring unit provided at a position between the support unit and the adjusting unit and exerting a restoring force on the container to return the container to an original position when the container is moved by a striking of the striking unit.

A fourth invention is the agitator according to the fifth invention, wherein the restoring unit has magnets, and wherein when the container is struck by the striking unit, at least a part of the magnets is separated from each other, and a magnetic force of the magnets acts on the container as the restoring force for returning the container to the original position.

A fifth invention is characterized in that the container has a lid for inserting the mixed object, and one of the magnets is provided on the support unit and the other magnets is provided on the lid.

A sixth invention is characterized in that the restoring unit has a polygonal cross section, and wherein when the container is struck by the striking unit and at least a part of the magnets is separated, one of polygonal sides of the restoring unit is in contact with each other.

A seventh invention is the agitator according to the second invention, wherein the support unit includes a press unit that pushes the container in a pressing direction, a contact surface that receives the container pushed by the press unit, and a wall provided to extend from the contact surface to the opposite side of the pressing direction, wherein the support unit defines a housing space for storing the one end portion and has an insertion opening for storing the one end portion in the housing space, and wherein the wall forms part of the insertion opening.

An eighth invention is the agitator according to described in any of the first to fourth inventions, wherein the striking unit is driven by the drive unit to oscillate around an oscillation axis, wherein the container is struck from a first direction by the striking unit and then alternately struck from a second direction different from the first direction by the oscillated striking unit.

A ninth invention provides an agitator including an outer shell holding a container with a mixed object, a support unit supporting the outer shell, a striking unit that continuously strikes the outer shell, and a driving unit that drives the striking unit.

A tenth invention provides a agitation method including supporting a container with a mixed object, and striking the container continuously by a striking unit driven by a driving unit.

### Effects of Invention

According to the first invention, the striking unit strikes the container to efficiently agitate the mixed object in the container. In addition, since the striking unit strikes the container continuously by the drive unit, the agitation can be performed under certain conditions. Various types of mixed objects can be agitated under desired conditions by optimally setting striking intervals of the striking unit according to the mixed object.

According to the second invention, the striking unit strikes the other end portion opposite the one end portion supported by the support unit, which increases a swing range of the other end portion. Thus, the impact and vibration can be applied to the mixed object efficiently. Furthermore, since the support unit supports the one end portion, the container can be efficiently agitated without falling therefrom.

According to the third invention, since the restoring unit exerts the restoring force on the one end portion so as to return the container to the original position, the mixed object is vibrated in the container by returning to the original position when the container is displaced by the strikes of the striking unit. As a result, the mixed object can be simultaneously given strikes by the striking unit and vibrations based on a displacement by the strikes and restoration of the restoring unit, thus enabling efficient agitation or the like. Especially, in comparison to the tapping shown in FIG. 29, uniform dispersion and improved yield can be achieved as well as dramatic improvement in operability in the preparation of lipid bimolecular membrane vesicles (liposomes, vesicles), colloids, and droplets. Since the restoring unit is provided between the adjusting unit and the support unit, the effect on the adjusting unit can be minimized by the restoring force acting thereon even if the support unit is displaced by the strike. This allows the restoring unit to return the container to a proper position adjusted by the adjusting unit. Furthermore, since the adjusting unit is provided, the other end of the container can be adjusted to an optimum position to be struck by the striking unit.

According to the fourth invention, since the restoring unit is consisting of the magnets, the restoring unit can be realized with a simple configuration. The magnetic force of the pair of magnets becomes stronger as they are to be closer. Therefore, even if a part of the magnets is separated, the strong restoring force is generated to immediately return the same to the original position. This allows for a faster vibration speed to be given to the container, thus enabling efficient agitation of the mixed object.

According to the fifth invention, since one magnet is provided on the lid of the container, the work of attaching and detaching the container to and from the support unit can be eliminated. This allows a configuration of an efficient mass production system when automating the agitator or incorporating the agitator into automated equipment.

According to the sixth invention, since the magnets have a polygonal cross section and a part of the sides of the magnets is in contact with each other even if at least a part of the magnets are separated, thereby reducing the occurrence of the misalignment between the adjusting unit and the support unit of the container by the strikes. This stabilizes the positional relationship between the support unit and the adjusting unit, thereby reducing the missed strike of the striking unit to the container.

According to the seventh invention, since the wall extending in the opposite side of the pressing direction forms part of the insertion opening, the wall prevents the one end portion from detaching from the housing space through the insertion opening. This avoids the container from falling due to the impact of the other end portion being struck by the striking unit. In addition, since the container is pushed by the press unit, the container can be held in the support unit in a simple method.

According to the eighth invention, the container is alternately struck by the striking unit from the first direction and the second direction different from the first direction, so that the mixed object can be efficiently agitated. In addition, since the striking unit strikes the container in different directions by oscillating around the oscillation axis, efficient agitation can be realized with a simple configuration.

According to the ninth invention, since the container containing the mixed liquid is held by the outer shell, the outer shell protects the container and prevents the mixed liquid from leaking outside due to the strike of the striking unit. In addition, since the striking unit strikes either the container or the outer shell, the mixed liquid can be efficiently agitated.

According to the tenth invention, the striking unit strikes the other end portion of the container, thereby efficiently agitating the mixed object in the container. In addition, since the striking unit strikes the other end portion of the container continuously, the agitation can be performed under certain conditions. Furthermore, various types of mixed objects can be agitated under desired conditions by optimally setting the striking interval of the striking unit according to the mixed object.

The present invention can provide the agitator and the agitation method capable of agitating etc. by striking the container under certain conditions.

### BRIEF DESCRIPTION OF DRAWING

FIG. 1 shows an overall perspective view of an agitator according to a first embodiment of the present invention.

FIG. 2 shows a front view of the vicinity of the container in the agitator according to the first embodiment of the present invention.

FIG. 3 shows an oblique view of a housing unit of the agitator according to the first embodiment of the present invention.

FIG. 4 shows a side view of the vicinity of the container of the agitator according to the first embodiment of the present invention.

FIG. 5 shows a block diagram of the agitator according to the first embodiment of the present invention.

FIG. 6 shows a flowchart of an agitating operations of the agitator according to the first embodiment of the present invention.

FIG. 7 shows a partial enlarged view of the vicinity of the container in the agitator according to the first embodiment of the present invention, FIG. 7A shows the container struck by an impactor to swing down, FIG. 7B shows the container displaced downward by the strike, FIG. 7C shows the container returned to an original position by a magnetic force, FIG. 7D shows the container struck by the impactor to swing up, and FIG. 7E shows the container returned to the original position by the magnetic force.

FIG. 8 shows a graph of the agitator showing the displacement of the other end of the container and the impactor in a top-bottom and a front-rear directions according to the first embodiment of the present invention.

FIG. 9 shows an external view of the container that has been agitated by the agitator according to the first embodiment of the present invention.

FIG. 10 shows an enlarged view of the mixed object that has been agitated by the agitator according to the first embodiment of the present invention.

FIG. 11 shows a front view of the vicinity of a container of an agitator according to a second embodiment of the present invention.

FIG. 12 shows a graph of the agitator showing a displacement of the other end of the container and an impactor in the front-rear and top-bottom directions according to the second embodiment of the present invention.

FIG. 13 shows a front view of the vicinity of a container in an agitator according to a third embodiment of the present invention.

FIG. 14 shows a plan view of the vicinity of a container in an agitator according to a fourth embodiment of the present invention.

FIG. 15 shows a front view of the vicinity of a container in an agitator according to a fifth embodiment of the present invention.

FIG. 16 shows a plan view of the vicinity of a container in an agitator according to a sixth embodiment of the present invention.

FIG. 17 shows a plan view of the vicinity of a container in an agitator according to a seventh embodiment of the present invention.

FIG. 18 shows a plan view of the vicinity of a container in an agitator according to an eighth embodiment of the present invention.

FIG. 19 shows a plan view of the vicinity of a container in an agitator according to a ninth embodiment of the present invention.

FIG. 20 shows a plan view of the vicinity of a container in an agitator according to a tenth embodiment of the present invention.

FIG. 21 shows a front view of the vicinity of a container in an agitator according to an eleventh embodiment of the present invention.

FIG. 22 shows a front view of the vicinity of a container in an agitator according to a twelfth embodiment of the present invention.

FIG. 23 shows a front view of the vicinity of a container in an agitator according to a thirteenth embodiment of the present invention.

FIG. 24 shows a front view of the vicinity of a container in an agitator according to a fourteenth embodiment of the present invention.

FIG. 25 shows a diagram of the vicinity of magnets in an agitator according to a fifteenth embodiment of the present invention.

FIG. 26 shows a conceptual diagram of the magnets in the agitator according to the fifteenth embodiment of the present invention.

FIG. 27 shows a plan view of a container according to a modification of the present invention.

FIG. 28 shows a plan view of the vicinity of a container of an agitator according to a modification of the present invention.

FIG. 29 shows a conventional agitating method.

### DESCRIPTION OF EMBODIMENTS

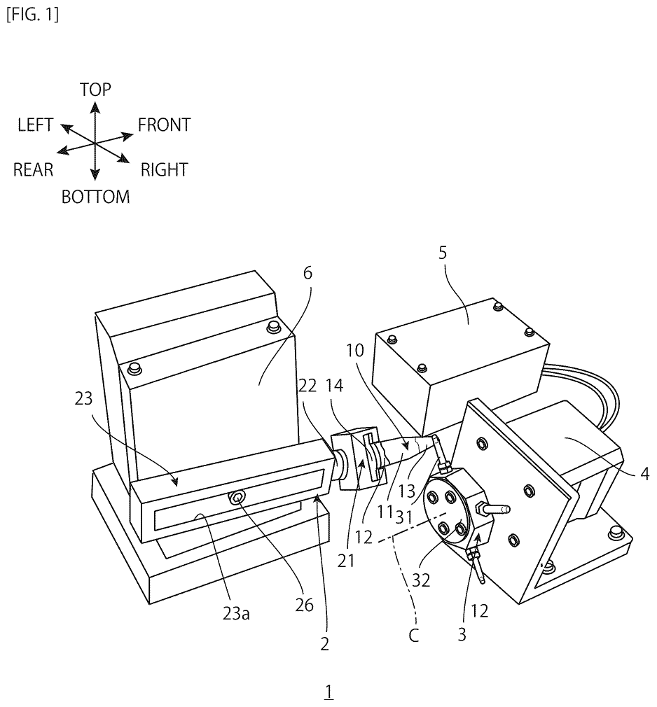

An agitator 1 according to a first embodiment of the present invention will be described based on FIGS. 1 to 10. In the description herein, “agitating, etc.” is a concept that includes at least one of: stirring; shaking; suspension; emulsification; dispersion; mixing; separation; membrane disruption of cells or particles having membranes; and disruption of cells or particles themselves or their aggregates. The agitator 1 can be used for the preparation of lipid unicellular membrane vesicles, lipid bimolecular membrane vesicles (liposomes, vesicles), colloids, and droplets used in the medical, pharmaceutical field, cosmetics, food, cell culture, chemical systems, and molecular robotics fields. In particular, the present invention can be used in the field of cell culture for the preparation of cell suspensions in regenerative medicine and biological experiments and in the field of pharmaceuticals for pinpoint transport of drugs to arbitrary locations in a body by means of drug delivery systems using lipid monolayer and bilayer vesicles, and for vaccines and gene delivery reagents. The applications of the agitator 1 are not limited to these but can be used to agitate or otherwise mix two or more different substances under desired conditions with reproducibility.

The agitator 1 performs an agitation, etc. by continuously striking at predetermined intervals a container 10 in which a mixed object 11 consisting of two or more different kinds of liquids is enclosed. The mixed object 11 are not limited to liquids, but may be at least two different types of powders or granules, or at least two different types of gelatinous materials, or at least two different types of viscous liquids. It may also be a mixture of at least two substances from among liquid, powder granules, gelatinous material, or viscous liquid. The agitator 1 includes a support unit 2 that supports a one end portion 12 of the container 10, a striking unit 3 configured to supply impacts to other end portion 13 opposite the one end portion 12 of the container 10 by the strikes, a drive unit 4 configured to drive the striking unit 3, a control unit 5 configured to control the drive unit 4, and a 3-axis table 6 that movably supports the support unit 2. In this embodiment, a microtube with a capacity of 0.2 ml to 2 ml is used as the container 10 but not limited to this, and any desired shape can be used. In the following description, the one end portion 12 of the container 10 is defined as a portion about ½ from a rear end of the container 10 in a front-rear direction, and the other end portion 13 is defined as a portion about ½ from the front end. As shown in the figure, the directions are defined as top, bottom, front, rear, left, and right. In the following explanation, when a direction such as forward is indicated, an abbreviated direction such as the abbreviated forward direction is included.

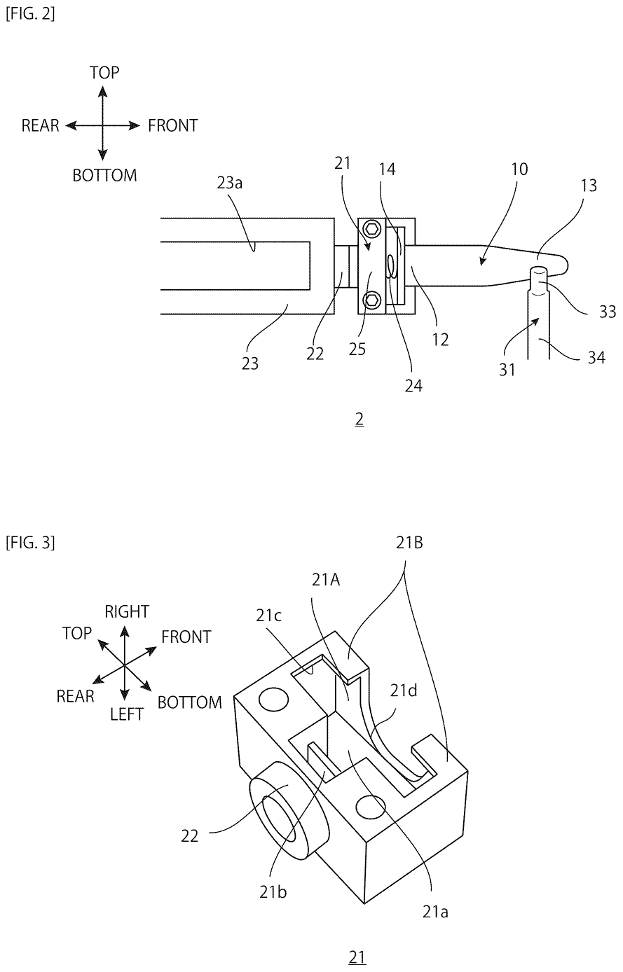

As shown in FIGS. 2 and 3, the support unit 2 includes a housing unit 21 removably holding the one end portion 12 with a lid 14 of the container 10, a pair of magnets 22, and an arm unit 23 movably fixed to the 3-axis table 6. The housing unit 21 has a spring 24 biasing the container 10 forward, a contact surface 21A in contact with the lid 14, and a wall 21B that prevents the container 10 from falling. The housing unit 21 defines a housing space 21a accommodating the lid 14, a spring housing space 21b accommodating the spring 24, and is formed with an insertion opening 21c for inserting the lid 14 of the container 10 into the housing space 21a, and an opening 21d in which the container 10 is exposed from the housing unit 21. The housing unit 21 has a rear end in which one of the pair of magnets 22 is fixed. The housing unit 21 is an example of a support unit of the present invention.

When the container 10 is accommodated in the housing unit 21, the lid 14 is brought into contact with the contact surface 21A by the spring 24 inserted into the spring housing space 21b. At this time, the one end portion 12 of the container 10 is exposed through the opening 21d. The wall 21B extends from the contact surface 21A toward the rear, opposite to the front direction as a pressing direction of the spring 24, and forms part of the insertion opening 21c. The walls 21B are spaced apart in the top-bottom direction so as to sandwich the opening 21d. The insertion opening 21c is substantially in rectangular shape, formed on the right side of the housing unit 21 and has a length vertically longer than the lid 14. The opening 21d is an abbreviated semi-circular shape, formed on the front side of the housing unit 21, and partially continues to the insertion opening 21c. When assembling the housing unit 21, the spring 24 is inserted into the spring housing space 21b from the state shown in FIG. 3 and a cover 25 is mounted as shown in FIG. 2. The spring 24 is an example of a press unit of the present invention. A plate spring, magnet, or other elastic material such as rubber may be used to bias the lid 14 instead of the spring 24.

The magnets 22 are cylindrical in shape, and one of the pair is fixed to the housing unit 21 and the other to the arm unit 23. The magnets 22 make the housing unit 21 removable and movable with respect to the arm unit 23. Moveable here means that a magnetic force returns the magnets 22 to its original position even if at least part of the magnets 22 is separated. The shape of the magnets 22 are not limited to the cylinder shape but may be a rectangular shape. The magnets 22 having a rectangular shape make it difficult for the housing unit 21 to rotate with respect to the arm unit 23 because the magnets are in contact at its sides even while container 10 is being struck. The magnets 22 are neodymium magnets in this embodiment but is not limited to this. Ferrite magnets, samarium cobalt magnets, alnico magnets, samarium cobalt magnets, or electromagnets can be used, and a yoke can also be employed. A retainer material may be provided around the magnets 22 to hold the same. In this case, the magnets 22 are desirably placed in a center of a holding material. The magnets 22 are an example of a restoring unit of the present invention.

The arm unit 23 has a predetermined length in the front-rear direction and is provided with an abbreviated rectangular long hole 23a through the center portion in the left right direction. The arm unit 23 is rotatably fixed to the 3-axis table 6 with a bolt 26. By loosening the bolt 26 and sliding the arm unit 23 back and forth, a front-rear position of the housing unit 21 can be adjusted, and by rotating the arm unit 23 around the bolt 26, an angle of the housing unit 21 can be adjusted. The arm unit 23 has a front end provided with the other of the pair of magnets 22. The arm unit 23 is an example of a support unit and an adjusting unit of the present invention.

As shown in FIG. 1, the striking unit 3 has an abbreviated rod-shaped impactor 31 and a rotating unit 32. The impactor 31 has a tip end provided with a small diameter portion 33 and a large diameter portion 34 larger in diameter than the small diameter portion 33. In this embodiment, the small-diameter portion 33 has 3 mm in diameter and 3 mm in length, and the large diameter portion 34 has 6 mm in diameter and 16.5 mm in length. The shape of the impactor 31 is not limited to this and the desired shape can be selected according to the shape and size of the container 10.

The rotating unit 32 is an abbreviated octagonal shape viewed from the rear, with a total of four impactors 31 extending radially outward on every other side. The rotating unit 32 is driven by the drive unit 4 to oscillate (reciprocate) clockwise, counterclockwise, or alternately around an oscillation axis C shown by a single-dotted line. The shape of the rotating unit 32 and the number of impactors 31 are not limited to this. The number of strikes on the container 10 can be increased by increasing the number of impactors 31, and the number of strikes can be decreased by decreasing the number of impactors 31. In this embodiment, a distance is 15.5 mm from a rotational center of the rotating unit 32 to a base of the impactor 31, but any length can be set according to the striking force on the container 10. The tip end of the impactor 31 is thinned by the small diameter portion 33, thereby avoiding the small diameter portion 33 from being caught on the other end portion 13 at the strike and the drive unit 4 from stopping due to overloading. In this embodiment, since the impactor 31 is driven by the drive unit 4 to strike the container 10 in a reciprocation manner from two directions, the number of impactors 31 need only be at least one. If the impactor 31 strikes the container 10 from one direction because the impactor 31 is rotated in only one direction by the rotating unit 32, a plurality of impactors 31 is required, desirably at least four impactors 31.

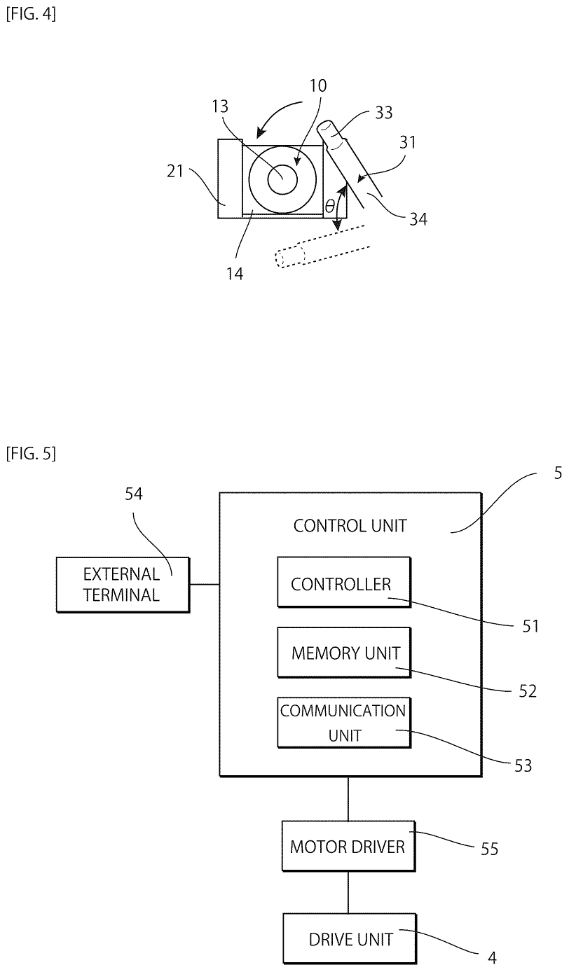

The impactor 31 strikes the container 10 such that the other end portion 13 and the small diameter portion 33 is brought into contact with each other as shown in FIGS. 2 and 4. In detail, the impactor 31 contacts the other end portion 13 so that the impactor 31 swings up or down in an abbreviated top-bottom direction against the container 10 extending horizontally, and continuously strikes and impacts the mixed object 11 in the container 10 at predetermined intervals. If the rotating unit 32 rotates in the clockwise or counterclockwise direction, after the impactor 31 strikes the other end portion 13, the next impactor 31 strikes the other end portion 13 from the same direction. As shown in FIG. 4, when the rotating unit 32 oscillates at an angle θ so as to rotate clockwise and then counterclockwise, after the impactor 31 strikes the other end portion 13 in a swing-down manner, the same impactor 31 strikes the other end portion 13 in a swing-up manner. In this embodiment, the drive unit 4 drives the impactor 31 so as to be in oscillate motion.

The drive unit 4 is a bipolar-wired stepping motor driven by an external power supply. The motor used for drive unit 4 is not limited to this, and any motor can be selected according to the application, such as a DC motor, brushless DC motor, AC motor, induction motor, or servo motor. When the DC motor, brushless DC motor, or AC motor is used, a mechanism for converting rotational motion to oscillating motion is desirably provided because such motors rotate in only one direction. The stepping motor in drive unit 4 may be unipolar wired. Furthermore, there is no limit to the number of phases of the stepping motor.

The control unit 5 is a microcomputer configured to control the drive unit 4. As shown in FIG. 5, the control unit 5 includes a controller 51, a memory unit 52, and a communication unit 53, and drive conditions for the drive unit 4 are input by an external terminal 54. The control unit 5 is electrically connected to the drive unit 4 via a motor driver 55. The controller 51 controls the entire control unit 5 and communication with the drive unit 4 and the external terminal 54. The memory unit 52 stores drive conditions of the drive unit 4 entered by the external terminal 54. The various parameters may be input for each agitating operation without the memory unit 52. The communication unit 53 is connected to the external terminal 54 and the drive unit 4 by a serial communication. The communication unit 53 outputs motor control signals to the motor driver 55, and the motor driver 55 outputs pulse signals to the drive unit 4. The communication method with the control unit 5 is not limited to this and may be wired, wireless, or parallel communication. The desired communication method can also be selected among USB, SUCI, Bluetooth (registered trademark), Wi-fi, IrDA, IDE, IEEE1394 (registered trademark), or Ethernet, etc. In this embodiment, an Arduino nano is used as the control unit 5 and an Arduino IDE is used as the software. The preparer sets an oscillation speed, oscillation angle, oscillation frequency, rotation speed, rotation direction, rotation frequency, and whether the rotation is in one direction or oscillation (reciprocation) of drive unit 4 to the control unit 5 with software from the external terminal 54. In this embodiment, the control unit 5 is operated by the external terminal 54, but various conditions may be set only by the control unit 5 without connecting the external terminal 54. Specifically, the control unit 5 may be connected with an LCD screen and switches or volumes directly, and parameters can be selected and determined with the switches and volumes while viewing the LCD screen.

The 3-axis table 6 is a table that can be fine-tuned in XYZ axes, and the arm unit 23 is fixed by the bolt 26. The position of the arm unit 23 can be fine-tuned by adjusting the 3-axis table 6. The 3-axis table 6 is an example of an adjusting unit of the present invention.

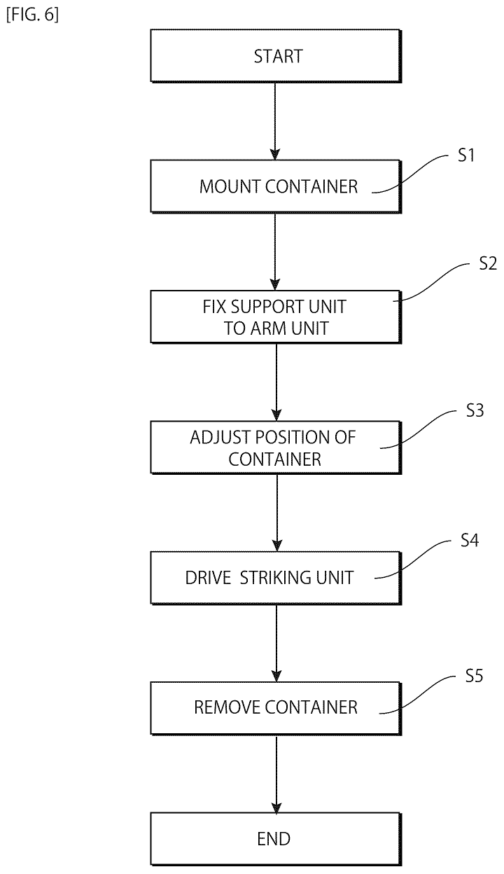

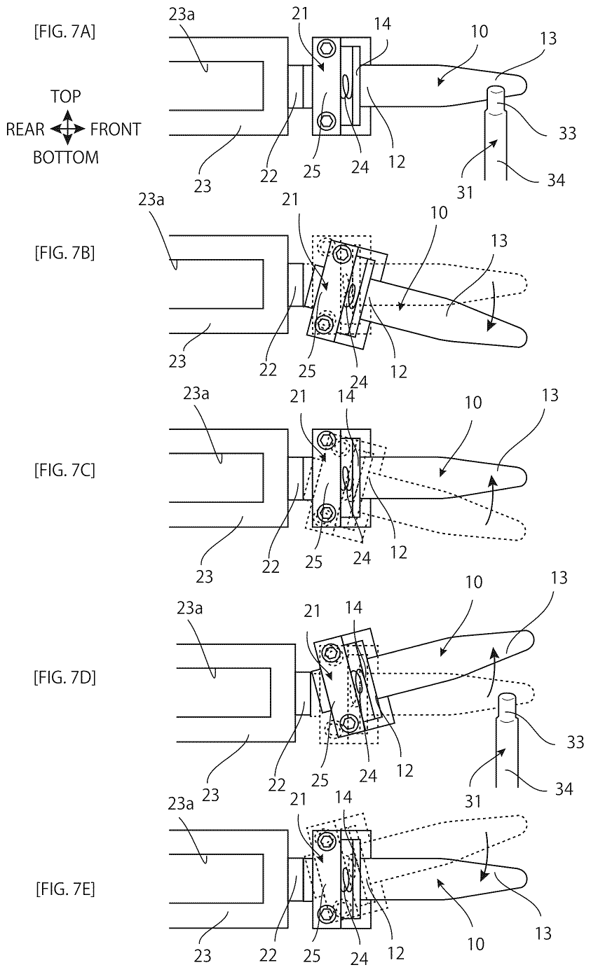

Next, the agitating etc. method of the container 10 using the agitator 1 will be described with reference to FIGS. 6 and 7. The preparer removes the housing unit 21 from the arm unit 23 by separating the pair of magnets 22 and accommodates the container 10 in the housing space 21a (S1). In detail, the lid 14 of the container 10 pushes the spring 24 rearward while inserting the one end portion 12 into the housing space 21a. At this time, the one end portion 12 is inserted along a long axis direction of the oval-shaped lid 14, and the container 10 presses the spring 24 rearward with the rotation to accommodate the lid 14 in the housing space 21a so that the long axis direction of the lid 14 extends in the top-bottom direction. As a result, the spring 24 presses the lid 14 against the contact surface 21A, and the sides of the lid 14 and the wall 21B are in contact or close proximity, which prevents the container 10 from falling out of the housing space 21.

The housing unit 21 with the container 10 attached is fixed to the arm unit 23 by the magnets 22 (S2). At this time, the housing unit 21 and the arm unit 23 are fixed so that approximate centers of the magnets 22 are aligned with each other. The container 10 is positioned by loosening the bolt 26, adjusting the angle and front-rear position of the arm unit 23 and the 3-axis table 6, and set the small diameter portion 33 of the impactor 31 to be in contact with the other end portion 13 (S3). At this time, the other end portion 13 is set to be struck near the approximate center of the small-diameter portion 33, thereby suppressing the missed strike of the impactor 31.

The drive unit 4 is driven for a predetermined time to cause the oscillating motion of the rotating unit 32, and the impactor 31 strikes the other end portion 13 multiple times continuously at regular intervals to impact the mixed object 11. The movement of the container 10 and the impactor 31 will be described in detail below with reference to FIG. 7.

As shown in FIG. 7A, when the small diameter portion 33 strikes the other end portion 13 downward from above, the impact from the strikes is applied to the mixed object 11. At the same time, the magnets 22 partially separates and the other end portion 13 is displaced downward as a struck direction as shown in FIG. 7B. The striking force of the impactor 31 is determined by an angular velocity of the rotating unit 32, the length and material etc. of the impactor 31. In this embodiment, the magnets 22 are set so as to partially but not completely separate from each other. The magnetic force of the magnets 22 becomes stronger as they are to be closer. Therefore, if the magnets 22 are partially separated while they are in partial contact, the strong magnetic force immediately returns the magnets 22 to the original position as shown in FIG. 7C. At this time, a center portion of the magnets 22 may be slightly misaligned due to the rotation of the housing unit 21 with respect to the arm unit 23, but the restoring force of the magnets 22 returns it to the original position, thereby eliminating significant misalignment and reducing the missed strike. The misalignment of the center portion of the magnets 22 can be alleviated or eliminated by changing the shape of the magnets 22 such as a rectangular or other polygonal shape, or by changing the shape of the housing unit 21.

Since the impactor 31 oscillates at the angle θ, the small diameter portion 22 strikes the other end portion 13 upward from below, as shown in FIG. 7D. In this way, the mixed object 11 is applied with the impact from the strike, and at the same time, the magnets 22 are separated and the other end portion 13 is displaced upward as the struck direction. The magnetic force of the magnets 22 becomes stronger as they are to be closer. If the magnets 22 are partially separated from each other while partially in contact, the strong magnetic force immediately returns the magnets 22 to the original state as shown in FIG. 7E. In other words, by striking the other end portion 13 continuously from above and below at a certain high speed and at regular intervals, the mixed object 11 can be subjected simultaneously to vibration from the displacement of the other end portion 13 and impact from the strikes.

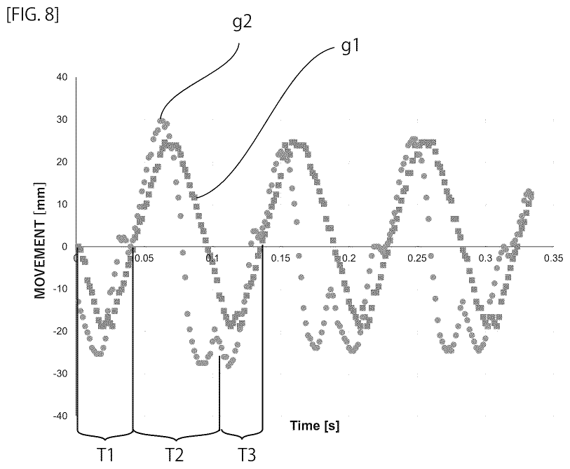

FIG. 8 shows a displacement of the container 10 while being struck by the impactor 31. Each point is plotted every 0.01/6 [s], a vertical axis representing an amount of displacement indicates the position [mm] of the other end portion 13 relative to the arm unit 23 with the original position set to 0, and a horizontal axis indicates the elapsed time [s]. A graph g1 represented by a square dot shows a position of the tip end of the impactor 31, and a graph g2 represented by a circle dot shows a position of a tip end of the other end portion 13. When a frequency of approximately 777.8 Hz is set in the program, an electrical signal of approximately 728.3 Hz is sent from the control unit 5 to the motor driver 55, and the electrical signal for driving is sent from the motor driver 55 to the drive unit 4. An oscillation frequency of the impactor 31 is set to 8.9 Hz, a reciprocation angle to 60°, and the number of reciprocations to 200. The other end portion 13 is struck downward from above in the first half of period T1 (from 0 sec. to approximately 0.02 sec.), causing the magnets 22 to separate as shown in FIG. 7B. Just before the small diameter portion 33 (tip end) of the impactor 31 reaches a maximum negative displacement, the other end portion 13 is released from the hook of the impactor 31 (approximately 0.02 seconds) and returns to the original position as shown in FIG. 7C by the magnetic force of the magnet 22. At this time, the magnets 22 are in contact with each other and a movement of the container 10 stops abruptly (second half of T1: from approximately 0.03 seconds to 0.04 seconds, the movement of the tube tip is temporarily stopped). Then, the other end portion 13 is struck upward from below by the impactor 31 in the first half of T2 (from the beginning of T2 to approximately 0.06 seconds) as shown in FIG. 7D. Just before the small diameter portion 33 (tip end) of the impactor 31 reaches a maximum positive displacement (approximately 0.06 seconds), the other end portion 13 is released from the hook of the impactor 31. The other end portion 13 momently returns to the original position as shown in FIG. 7E without staying in the original position and swings out of the original position under the influence of the restoring force of magnets 22 to the state shown in FIG. 7B (approximately 0.09 seconds). Each plot has an interval becoming wider from approximately 0.07 to 0.08 seconds of the period T2, because the distance between the magnets 22 becomes narrower and the acceleration increases inversely proportional to the square of the distance, resulting in an increase in speed. Even after the other end portion 13 returns to the original position, the interval between each plots continues to widen due to the inertia and gravity of the container 10 (approximately 0.08 seconds). Eventually the speed of the other end portion 13 is reduced due to the restoring force, the interval between each plots narrows, the speed becomes zero, and then the restoring force moves the other end portion 13 from bottom to top (from approximately 0.09 seconds to 0.10 seconds). The g2 has a slope larger absolute value than that of g1, which indicates that the other end portion 13 is moving at a higher speed than the smaller diameter portion 33 (tip end) of the impactor 31. Although the container 10 temporarily stays in the original position due to the contact of the magnets 22 when the container 10 swings up, the container 10 does not stay in the original position when the container 10 swings down, because the effect of gravity may be affected. The mixed object 11 can be efficiently agitated by the high-speed displacement from FIG. 7B to FIG. 7E. The magnets 22 are in contact with each other again and the movement of the container 10 stops abruptly at the end of period T3 (approximately 0.13 seconds). Thereafter, the magnets 22 are again struck upward from below, causing the magnets 22 to separate and the container 10 to displace abruptly. The interval between the plots of the graph g1 is almost the same for all periods T1 to T3 time, and the oscillation is occurring at almost the same acceleration. The graph g2 has two peaks from approximately 0.08 seconds of period T2 to 0.12 seconds of period T3, which indicates that the impactor 31, which is delayed in descending, strikes the container 10 downward again.

After the impactor 31 is driven for a predetermined time, the housing unit 21 is separated from the arm unit 23 and the container 10 is removed from the housing unit 21 (S5).

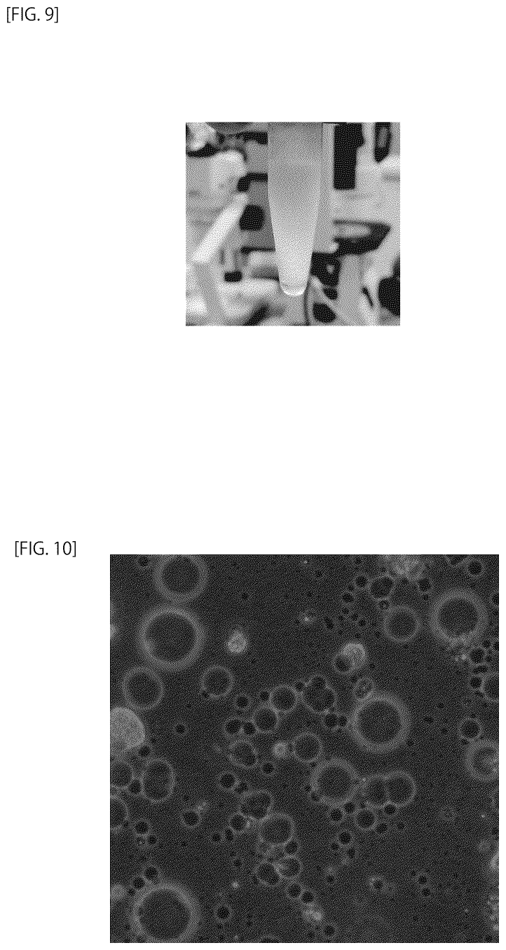

Next, tests using the agitator 1 will be described. The tests described below are conducted under conditions different from the agitating conditions shown in FIG. 8 above. The container 10 uses a 1.5 ml Violamo microtube having flat bottom, and 500 μL of water and 500 μL of olive oil are used as the mixed object 11. The container 10 is agitated etc. by the agitator 1 whose oscillating frequency is set to 12.9 Hz and oscillating angle is set to 60° for 200 strikes. The results are shown in FIG. 9. Compared to the drive condition in FIG. 8, this condition is more appropriate for the impactor 31 to strike down from above and up from below, and the impactor 31 can strike the other end portion 13 more effectively. The mixed object 11 is mixed so as to be dispersed in an approximately uniform manner as shown in FIG. 9. FIG. 10 shows liposomes prepared by agitating other materials in the agitator 1. As shown in the figure, it is confirmed that the agitator 1 can generate fine lipid bimolecular membrane vesicles.

According to the configuration, the striking unit 3 strikes the other end portion 13 of the container 10 to efficiently agitate etc. the mixed object 11 in the container 10. In addition, since the striking unit 3 strikes the other end portion 13 of the container 10 continuously at predetermined intervals by the drive unit 4, the agitating etc. can be performed under certain conditions. Various types of mixed objects 11 can be agitated etc. under desired condition by optimally setting the striking intervals of the striking unit 3 according to the mixed object 11. The striking unit 3 strikes the other end portion 13 on the opposite side of the one end portion 12 supported by the support unit 2, which increases the swing range of the other end portion 13. This allows greater impact and vibration to be applied to the mixed object 11. Furthermore, since the support unit 2 supports the one end portion 12, the container 10 can be efficiently agitated etc. without falling therefrom.

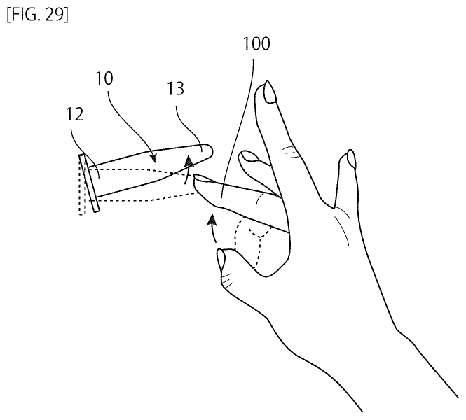

According to the configuration, since the magnets 22 exert the magnetic force on the one end portion 12 so as to return the movement of the one end portion 12 to the original position, the mixed object 11 is vibrated in the container 10 when the one end portion 12 is displaced by the strikes from the striking unit 3. As a result, the mixed object 11 can be simultaneously given the strike by the striking unit 3 and the vibration based on the displacement by the strike and restoration by the magnets 22, thus enabling efficient agitation or the like. Especially, in comparison to the tapping shown in FIG. 29, uniform dispersion and improved yield can be achieved as well as dramatic improvement in operability in the preparation of lipid unicellular membrane vesicles, lipid bimolecular membrane vesicles (liposomes, vesicles), colloids, and droplets. Since the magnets 22 are provided between the arm unit 23 and the housing unit 21, the effect on arm unit 23 can be minimized by the magnetic force acting thereon even if the housing unit 21 is displaced by the strike. This allows the magnets 22 to the return container 10 to the proper position adjusted by the arm unit 23. Furthermore, since the arm unit 23 and the 3-axis table 6 are provided, the other end portion 13 of the container 10 can be adjusted to the optimum position to be struck by the striking unit 3.

According to the configuration, the magnets 22 are provided between the housing unit 21 and the arm unit 23, and the magnetic force of the pair of magnets becomes stronger as they are to be closer, the magnets immediately return the original position when being separated. This allows the strong restoring force to be exerted on the one end portion 12 against the displacement of the container 10. Further, the vibration speed given to the container 10 can be increased, resulting the mixed object 11 to be efficiently agitated or the like.

According to the configuration, since the wall 21B extends in the opposite side of the pressing direction in which the spring 24 presses the container 10 and forms part of the insertion opening 21c, the wall 21B prevents the one end portion 12 from detaching from the housing space 21a through the insertion opening 21c. This avoids the container 10 from falling due to the impact of the other end portion 13 being struck by the striking unit 3. In addition, since the container 10 is pushed forward by the spring 24, the container 10 can be held in the housing space 21 in a simple method.

According to the configuration, the container 10 is alternately struck by the striking unit 3 in the direction of swinging down from above and swinging up from below, so that the mixed object 11 can be efficiently agitated or the like. In addition, since the striking unit 3 strikes the container 10 in different directions by oscillating around the oscillating axis C, efficient agitation etc. can be realized with a simple configuration.

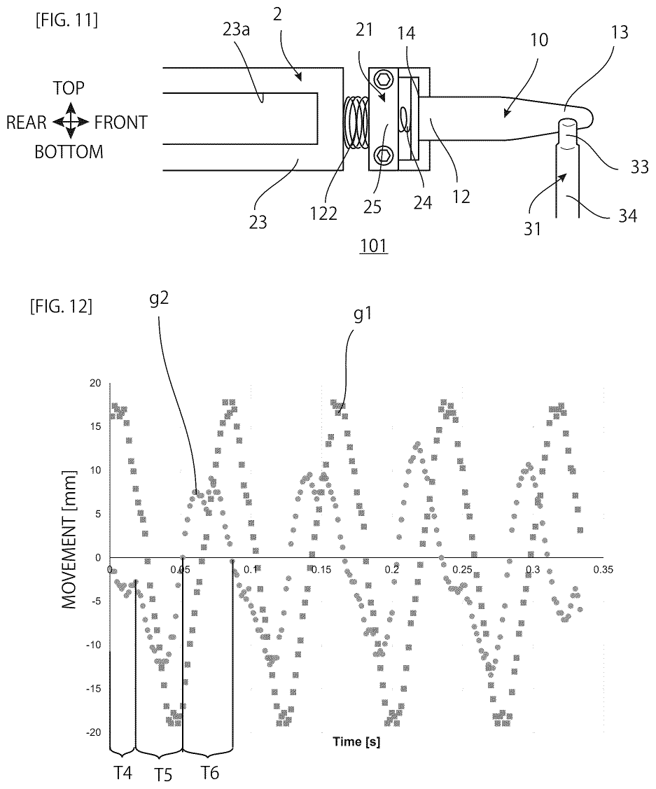

Next, a second embodiment of the present invention will be described with reference to FIGS. 11 and 12. The same configuration as in the first embodiment is indicated with the same symbol and the explanation is omitted.

The support unit 2 of an agitator 101 includes the housing unit 21, a spring 122, and the arm unit 23. In the second embodiment, the spring 122 consisting of metal is used instead of the magnets 22 of the first embodiment. The spring 122 is an example of the restoring unit of the present invention provided between the housing unit 21 and the arm unit 23.

FIG. 12 shows a displacement of the container 10 when being struck by the impactor 31. As in the first embodiment, each point is plotted every 0.01/6 [s], a vertical axis representing an amount of displacement indicates an angle of the other end portion 13 relative to the arm unit 23, and a horizontal axis indicates an elapsed time. A graph g1 represented by square dots shows a position of the tip end of the impactor 31, and a graph g2 represented by round dots shows a position of the tip end of the other end portion 13. A frequency of approximately 1000 Hz is set on the program, and an electrical signal for driving is sent from the motor driver 55 to the drive unit 4. An oscillation frequency of the impactor 31 is set to 12.9 Hz, a reciprocation angle to 60°, and the number of reciprocations to 200. As shown in FIG. 12, the displacement of the spring is small in period T4, so a restoring force is smaller, a speed of movement becomes slower, and thus intervals between each plot becomes narrower. In other words, the container 10 remains in the original position, albeit temporarily. The other end portion 13 is struck downward from above from the end of T4 (approximately 0.02 seconds) to the first half of T5 (approximately 0.03 seconds), deforming the spring 122 and displacing the container 10 downward. After the strike, the other end portion 13 of the container 10 is released from the hook of the small diameter portion 33 (tip end) of the impactor 31 in the middle of T5 (approximately 0.04 seconds), and the container 10 returns to the original position by the restoring force of the spring 122 during the latter half of the period T5 (approximately 0.04 seconds to 0.05 seconds). Thereafter, the other end portion 13 swings up due to an inertia force without staying in the original position (approximately 0.05 to 0.06 seconds) and begins to fall downward from above (approximately 0.06 to 0.07 seconds) due to the restoring force of spring 122. Immediately after that, the impactor 31, which is delayed in ascending, again strikes bottom to top in the middle of period T6 (approximately 0.07 seconds), displacing upward. However, the missed strike occurs after 0.20 seconds in the figure because the restoring force of the spring does not match the cycle of the strikes. The missed strike can be suppressed by setting the conditions of the drive unit 4 and selecting the appropriate spring constant. The interval between the plots of container 10 widens in approximately 0.05 seconds and from approximately 0.08 to 0.09 seconds, because a center of an amplitude of the vibration is the fastest due to the restoring force of the spring 122. Specifically, this is because a positional energy of the spring 122 is at its minimum and a kinetic energy is at its maximum. In other words, the displacement corresponding to FIG. 7B to FIG. 7E takes place at high speed, thereby efficiently agitating etc. the mixed object 11.

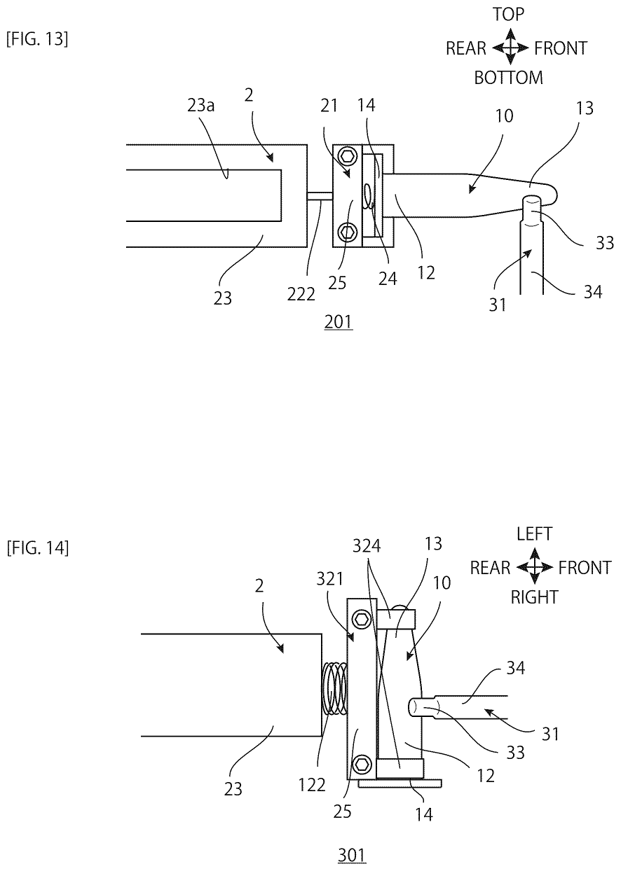

Next, a third embodiment of the present invention will be described with reference to FIG. 13. The same configuration as in the first embodiment is indicated with the same symbol and the explanation is omitted.

The support unit 2 of an agitator 201 has the housing unit 21, a plate spring 222, and the arm unit 23. In other words, the second embodiment uses a spring 122 consisting of metal instead of the magnets 22 of the first embodiment. The plate spring 222 is an example of the restoring unit of the present invention provided between the housing unit 21 and the arm unit 23. In the agitator 201, desired agitating conditions can be set by selecting the material and shape of the plate spring 222.

Next, a fourth embodiment of the present invention will be described with reference to FIG. 14. The same configuration as in the first embodiment is indicated with the same symbol and the explanation is omitted.

The support unit 2 of an agitator 301 includes a housing unit 321, the spring 122, and the arm unit 23. The housing unit 321 has the cover 25 extending in the left-right direction and a pair of retaining belts 324 for holding the container 10 on the cover 25.

In the fourth embodiment, the container 10 has left and right ends held by the housing unit 21, and the impactor 31 strikes the approximate center portion of the container 10 in the left right direction. This allows the container 10 to be entirely vibrated. The magnet 22, the plate spring 222, resin, or other elastic member may be used instead of the spring 122.

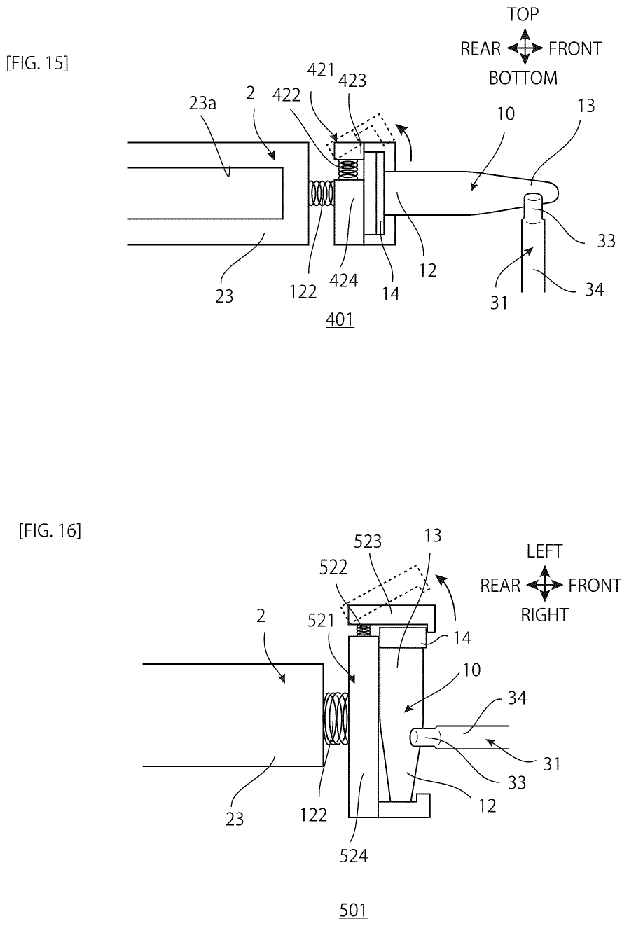

Next, a fifth embodiment of the present invention will be described with reference to FIG. 15. The same configuration as in the above embodiments is indicated with the same symbol and the explanation is omitted.

The support unit 2 of an agitator 401 includes a housing unit 421 provided with a spring 422, a movable unit 423, and a fixed unit 424 connected to the movable unit 423 via the spring 422 and to the support unit 2 by the spring 122. The movable unit 423 is rotatable in an arrowing direction by the spring 422 as shown by a dotted line in the figure and holds an upper end of the lid 14. The fixed unit 424 is connected to the arm unit 23 via the spring 122 and holds the lower end of the lid 14. When mounting the container 10 in the housing unit 421, the movable unit 423 is rotated in the arrowing direction to fix the lower end of the lid 14 to the fixed unit 424, and the upper end of the lid 14 is fixed by returning the movable unit 423 to its original position. This allows the container 10 to be attached to and removed from the housing unit 421 with a simple structure. The magnet 22, the plate spring 222, resin, or other elastic member may be used instead of the spring 422.

Next, a sixth embodiment of the present invention will be described with reference to FIG. 16. The same configuration as in the above embodiments is indicated with the same symbol and the explanation is omitted.

The support unit 2 of an agitator 501 includes a housing unit 521 provided with a spring 522, a movable unit 523, and a fixed unit 524 connected to the movable unit 523 via the spring 522 and to the support unit 2 by the spring 122. The movable unit 523 is rotatable in an arrowing direction by the spring 522 as shown by a dotted line in the figure and holds the other end portion 13 side of the container 10. The fixed unit 524 is connected to the arm unit 23 via the spring 122 and holds the one end portion 12 side. When mounting the container 10 in the housing unit 521, the movable unit 523 is rotated in the arrowing direction to fix the one end portion 12 of the container 10 to the fixed unit 524, and the movable unit 523 is returned to its original position to fix the other end portion 13. This allows the container 10 to be attached to and detached from the housing unit 521 with a simple structure.

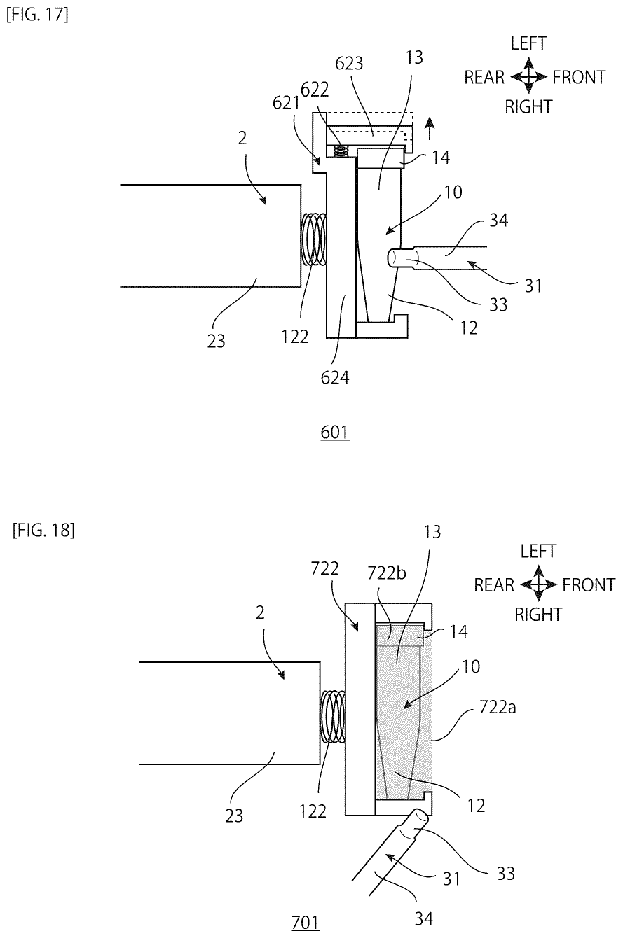

Next, a seventh embodiment of the present invention will be described with reference to FIG. 17. The same configuration as in the above embodiments is indicated with the same symbol and the explanation is omitted.

The support unit 2 of an agitator 601 includes a housing unit 621 provided with a spring 622, a movable unit 623, and a fixed unit 624 connected to the movable unit 623 via the spring 622 and connected to the support unit 2 by the spring 122. The spring 622 biases the movable unit 623 to the right. The movable unit 623 is movable in an arrowing direction by the spring 622 as shown by the dotted line in the figure and holds the one end portion 12 side of the container 10. The fixed unit 624 is connected to the arm unit 23 via the spring 122 and holds the other end portion 13 side. When mounting the container 10 in the housing unit 621, the movable unit 623 is translated in the arrowing direction, the other end portion 13 of the container 10 is fixed to the fixed unit 624, and then the movable unit 623 is returned to its original position. This allows the container 10 to be attached to and detached from the housing unit 621 with a simple structure.

Next, an eighth embodiment of the present invention will be described with reference to FIG. 18. The same configuration as in the above embodiments is indicated with the same symbol and the explanation is omitted.

The support unit 2 of an agitator 701 includes a housing unit 721 provided with an outer shell 722 that accommodates the container 10. The outer shell 722 has a front end portion formed with an opening 722a and the container 10 passes through the opening 722a when being attached or detached. The outer shell 722 has an interior space 722b represented by a gray-colored area. When attaching the container 10 to the housing unit 721, the one end portion 12 is clamped by a right end portion of the outer shell 722, and the other end portion 13 is clamped by a left end portion of the outer shell 722.

Next, the agitation method of the agitator 701 will be described. The small diameter portion 33 of the impactor 31 strikes the right end of the outer shell 722 continuously so that the container 10 is oscillated from the front side to the rear side of the paper, and the vibration and the impact are transmitted to the container 10 through the outer shell 722 to agitate the mixed object 11. The strike point of the small diameter portion 33 is not limited to this and may be any desired location on the outer shell 722 or the container 10. For example, the container 10 may be struck directly through the opening 722a.

According to the configuration, the impactor 31 strikes the outer shell 722 instead of the container 10, thereby suppressing a deterioration of the container 10 due to direct striking of the container 10, and the mixed object 11 can be agitated effectively. In addition, since the container 10 is covered by the outer shell 722, the container 10 can be prevented from falling.

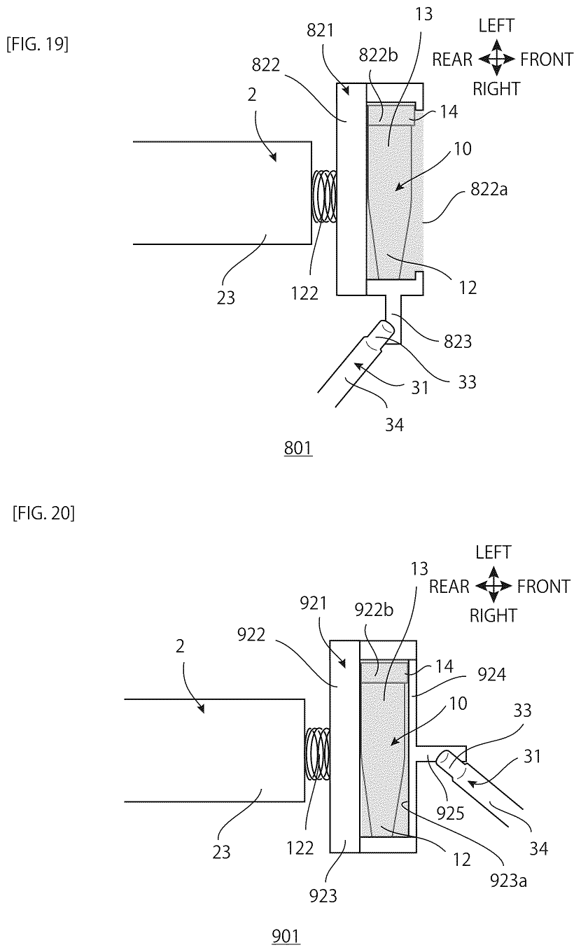

Next, a ninth embodiment of the present invention will be described with reference to FIG. 19. The same configuration as in the above embodiments is indicated with the same symbol and the explanation is omitted.

The support unit 2 of an agitator 801 includes a housing unit 821 having an outer shell 822 that accommodates the container 10. The outer shell 822 has a struck unit 823 having an abbreviated cylindrical-shape and protruding rightward, and a front portion formed with an opening 822a through when the container 10 is attached or detached. The outer shell 822 has an interior space 822b represented by the gray-colored area. when attaching the container 10 to the housing unit 821, the one end portion 12 is clamped by a right end portion of the outer shell 822 and the other end portion 13 is clamped by a left end portion of the outer shell 822 to fix the container 10 to the interior space 822b.

Next, the agitation method of the agitator 801 will be described. The small diameter portion 33 of the impactor 31 strikes the struck unit 823, causing the vibration and the impact to be transmitted to the container 10 through the struck unit 823 and the outer shell 822, thereby agitating the mixed object 11.

According to the configuration, the impactor 31 strikes the struck unit 823 protruding from the outer shell 822, thereby reducing the missed strike of the impactor 31 and suppressing the deterioration of the container 10 due to the direct striking of the container 10. In addition, because the container 10 is covered by the outer shell 822, the container 10 can be prevented from falling.

Next, a tenth embodiment of the present invention will be described with reference to FIG. 20. The same configuration as in the above embodiments is indicated with the same symbol and the explanation is omitted.

The support unit 2 of an agitator 901 includes a housing unit 921 provided with an outer shell 922 that accommodates the container 10. The outer shell 922 has a receiving unit 923 formed with an opening 923a and a cover portion 924 that closes the opening 923a. The cover portion 924 includes a struck unit 925 having cylindrical shape and protruding forward. The outer shell 922 has a closed interior space 922b representing gray-colored area. When mounting the container 10 in the housing unit 921, the cover portion 924 is removed from the receiving unit 923, the one end portion 12 is engaged with a right end portion of the outer shell 822 and the other end portion 13 is engaged with a left end portion of the outer shell 822 to place the container 10 the interior space 922b, and the opening 923a is closed with the cover portion 924.

Next, the agitation method of the agitator 901 will be described. The small diameter portion 33 of the impactor 31 strikes the struck unit 925, which causes the vibration and the impact to be transmitted to the container 10 through the struck unit 925 and the outer shell 922, thereby agitating the mixed object 11.

According to the configuration, since the impactor 31 strikes the struck unit 925 protruding from the outer shell 922, thereby reducing the missed strike of the impactor 31 and suppressing deterioration of the container 10 due to the direct striking of the container 10. In addition, since the container 10 is completely and peripherally covered by the outer shell 922, the container 10 can be prevented from falling.

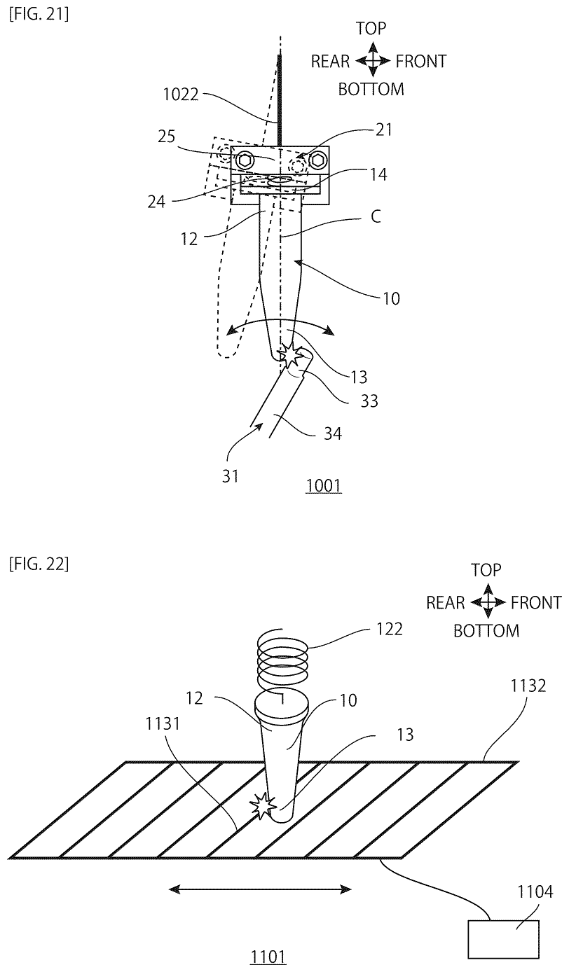

Next, an eleventh embodiment of the present invention will be described with reference to FIG. 21. The same configuration as in the above embodiments is indicated with the same symbol and the explanation is omitted.

The housing unit 21 of the support unit 2 of an agitator 1001 is connected to the support unit 2 via a wire 1022. The housing unit 21 supports the container 10 so that the other end portion 13 orients downward, and gravity stabilizes the container 10 in a position shown in the figure. The housing unit 21 is connected to the support unit 2 via the wire 1022, but elastic materials such as resin, springs, etc. may be used. The impactor 31 oscillates in a circular arc in the front-rear direction as shown by the arrows.

Next, the agitation method of the agitator 1001 will be explained. The small-diameter portion 33 of the impactor 31 strikes the other end portion 13 of the container 10 so as to swing back and forth about a central axis C to either side as shown by the dotted line in the figure, but gravity exerts a force to return the container 10 to a position shown by the solid line. In other words, gravity is used as the restoring force in this embodiment. By using other elastic materials instead of the wire 1022, gravity and elasticity can be used as the restoring force. The container 10 swings about the central axis C as the small diameter portion 33 strikes the other end portion 13 again after returning to the original position. The impactor 31 reciprocates and strikes the container 10, thereby agitating the mixed object 11.

According to the configuration, the container 10 can be returned to the original position with a simple configuration by using gravity as the restoring force. In addition, the elastic force can be used as the restoring force in addition to gravity by using an elastic material instead of the wire 1022, enabling efficient agitation.

Next, a twelfth embodiment of the present invention will be described with reference to FIG. 22. The same configuration as in the above embodiments is indicated with the same symbol and omitted from the explanation. Note that FIG. 22 is a schematic diagram, and detailed configurations of the housing and other parts are omitted.

An agitator 1101 has the spring 122 detachably connected to the container 10. The spring 122 supports the container 10 so that the other end portion 13 orients downward, and gravity stabilizes the container 10 in a position shown in the figure. The striking unit 1103 has a striking rail 1132 with impactors 1131 and a drive unit 1104 configured to drive the striking rail 1132 in a reciprocation manner in the front-rear direction. The impactors 1131 are equally spaced in the front-rear direction, and the striking rail 1132 has an abbreviated ladder shape and is reciprocated in the direction of an arrow by the drive unit 1104. An interval at which the impactors 1131 strike the other end portion 13 can be set arbitrarily according to a distance of the impactors 1131 in the front-rear direction and the drive conditions of the drive 1104.

Next, the agitation method of the agitator 1101 will be described. When the drive unit 1104 drives the striking rail 1132 in the reciprocate manner, the impactor 1131 strikes the other end portion 13 continuously at predetermined intervals. When the impactor 1131 strikes the other end portion 13, the other end portion 13 swings in the struck direction. The spring 122 and gravity exert on the container 10 as the restoring force, and container 10 tends to return to its original position. The impactor 1131 adjacent to the impactor 1131 that has been just struck strikes the other end portion 13 in the same direction again. After the striking rail 1132 has moved a predetermined distance, the striking rail 1132 moves in the opposite direction. At this time, the impactor 1131 strikes the other end portion 13 continuously in the same manner. The movement of the striking rail 1132 is not limited to the reciprocation manner, but can achieve the same effect as long as the movement is closed, such as a circular motion, a figure-eight motion, or other motion with a flat surface or other startup. Specifically, the container 10 may be configured to be struck from a predetermined direction and then struck from a different direction than the predetermined direction by means of the circular motion, the figure eight motion, etc. The spring 122 is an example of the restoring unit and the support unit of the present invention, and the striking rail is an example of the striking unit of the present invention.

According to the configuration, the mixed object 11 can be efficiently agitated with a simple configuration in which the striking rail 1132 strikes the container 10 in the reciprocation manner. Although the container 10 is held by the housing unit 21 in this embodiment, the housing unit shown in above embodiments may be applied.

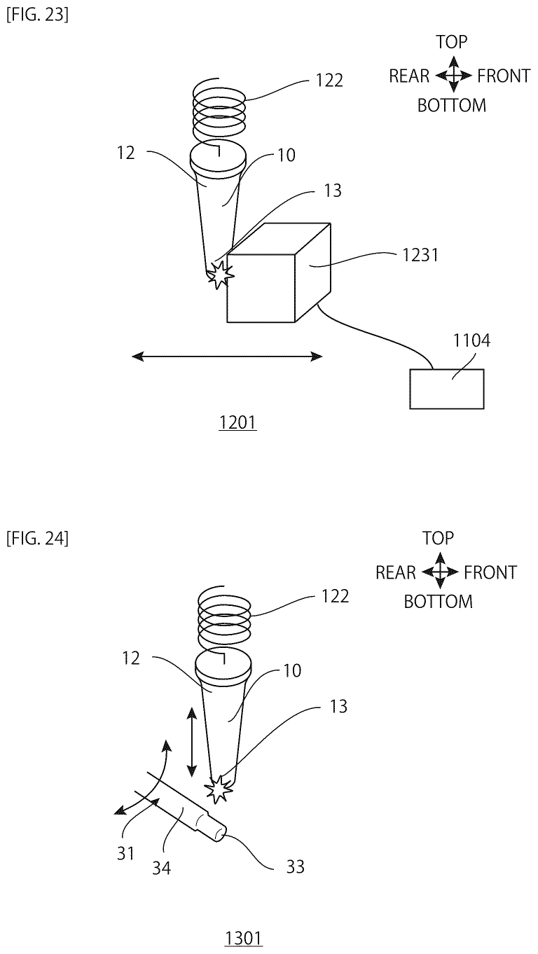

Next, a thirteenth embodiment of the present invention will be described with reference to FIG. 23. The same configuration as in the above-mentioned embodiment is indicated with the same symbol and the explanation is omitted. FIG. 23 is a schematic diagram and omits detailed configurations of the housing and other parts.

The spring 122 is detachably connected to the container 10 in an agitator 1201. The spring 122 supports the container 10 so that the other end portion 13 orients downward, and gravity stabilizes the container 10 in a position shown in the figure. A striking unit 1203 includes an impactor 1231 having a rigid body and an abbreviated rectangular shape, and the drive unit 1104 that reciprocally drives the impactor 1231 in the front-rear direction indicated by an arrow. An interval at which the impactor 1231 strikes the other end portion 13 can be set arbitrarily according to the drive conditions of the drive unit 1104.

Next, the agitation method of the agitator 1201 will be explained. When the drive unit 1104 drives the impactor 1231 back and forth, the impactor 1231 strikes the other end portion 13 rearward. When the impactor 1231 strikes the other end portion 13, the other end portion 13 swings rearward. The spring 122 and gravity exert on container 10 as the restoring force, causing the container 10 to return to its original position. The impactor 1231 reciprocates and strikes the other end portion 13 from frontward again.

According to the configuration, the container 10 can be struck and the mixed object 11 can be efficiently agitated by the simple configuration of reciprocating the impactor 1231. Although the container 10 is held by the housing unit 21 in this embodiment, the housing unit of the above embodiments may be applied.

Next, a fourteenth embodiment of the present invention will be described with reference to FIG. 24. The same configuration as in the above-mentioned embodiment is indicated with the same symbol and the explanation is omitted. FIG. 24 is a schematic diagram and omits detailed configurations of the housing unit and other parts.

The spring 122 detachably connected to the container 10 in an agitator 1301. The spring 122 supports the container 10 so that the other end portion 13 orients downward, and gravity stabilizes the container 10 in a position shown in the figure. When the impactor 31 oscillates in an arc as shown by an arrow, the impactor 31 strikes the other end portion 13, causing the other end portion 13 to swing upward. The spring 122 and gravity exert on the container 10 as the restoring force, causing the container 10 to move downward to tend to return to its original position. The impactor 31 then swings in an arrowing direction, striking the other end portion 13 from downward to upward again. The spring 122 is an example of the restoring unit and the support unit of the present invention.

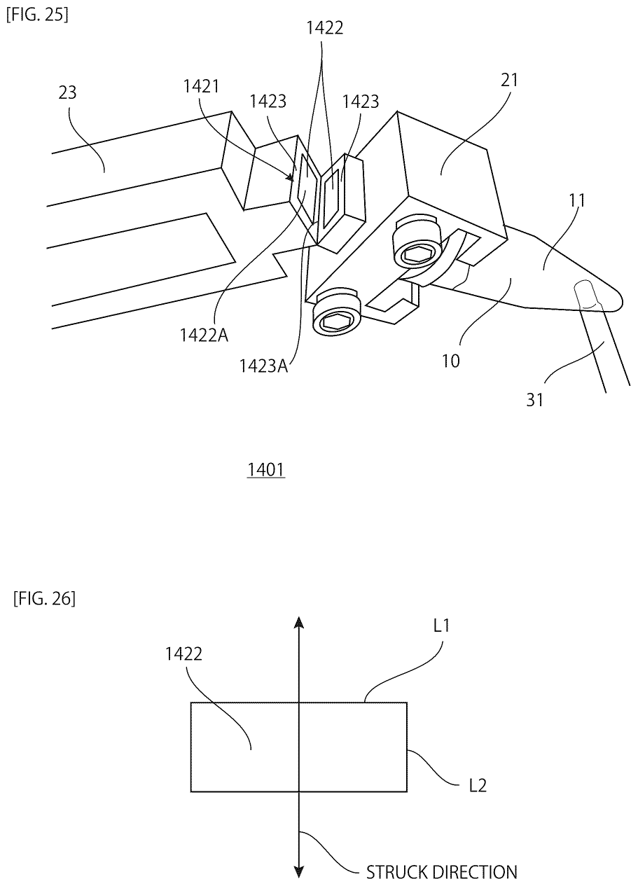

Next, a fifteenth embodiment of the present invention will be described with reference to FIGS. 25 and 26. The same configuration as in the embodiment described above is indicated with the same symbol and omitted from the explanation. FIG. 26 is a schematic diagram and omits the detailed configuration of the housing and other parts. In the fifteenth embodiment, an agitator 1401 has a magnet unit 1421 with an abbreviated rectangular cross section instead of the magnet 22.

The magnet unit 1421 in an abbreviated rectangular shape has a pair of magnets 1422, and a magnet holder 1423 for holding the magnets 1422. The magnets 1422 have a contact surface 1422A having rectangular cross section. The magnet holder 1423 has a rectangular cross section and surrounds the magnet 1422. As shown in FIG. 25, when the container 10 has been struck by the impactor 31, the magnets 1422 are separated and the container 10 is displaced diagonally downward. At this time, the magnet unit 1421 is partially in contact at a contact edge 1423A of the magnet holder 1423, which is located in the struck direction of the magnet 1422. Specifically, when the impactor 31 strikes the container 10 from top to bottom, the magnet unit 1421 and the magnets 1422 are in contact with each other only at the contact edge 1423A, which is the lower edge of the magnet unit 1421, and the magnet unit 1421 and the magnets 1422 are separated in other parts. Then, the contact surfaces 1422A contact each other and the container 10 returns to its original position due to the magnetic force of the magnets 1422.

As shown in FIG. 26, the contact surface 1422A has long sides L1 and short sides L2. The long side L1 is vertical to the struck direction D and the short side L2 is horizontal thereto. This allows the contact side 1422B to be the long side L1, thereby inhibiting the rotation of the housing unit 21 with respect to the arm unit 23 during the strike. In other words, the contact portion is larger when the contact edge 1423A is the long edge L1 compared to a case where the contact edge 1423A is the short edge L2, and thus the rotation of the housing unit 21 with respect to the arm unit 23 can be inhibited during the strike. In the first embodiment, the container 10 tends to be rotated because the magnets 22 has cylindrical in shape and contacts at a point when the magnets 22 are separated. In contrast, the magnet unit 1421 according to the fifteenth embodiment can suppress the rotation of the container 10 with respect to the arm unit 23, thus reducing the missed strike of the impactor 31 due to the misalignment of the container 10. The magnet unit 1421 is an example of the restoring unit of the present invention.

According to the configuration, the magnets 1422 have the rectangular cross section and the contact edges 1423A of the magnet units 1421 are in contact with each other while at least a part of the magnets 1422 are separated, thereby reducing the occurrence of the misalignment between the housing unit 21 of the container 10 and the arm unit 23 due to being struck by the impactor 31. The positional relationship between the housing unit 21 and the arm unit 23 can be stabilized, thereby reducing the missed strike of the impactor 31 to the container 10.

The agitator and the agitation method according to the present invention are not limited to the embodiments described above, and various modifications can be made within the scope of the claims of the present invention.

In the above embodiment, the arm unit 23 held the container 10 in an abbreviated horizontal direction, but not limited to this. For example, the arm unit 23 may hold the container 10 in an abbreviated vertical direction, and the impactor 31 may be in a horizontal position so as to strike the other end portion 13. This allows the precipitable mixed object 11 to agitate etc. more efficiently, because the other end portion 13 is struck while precipitates of the mixed object 11 are collected below.

In the above embodiment, the magnet 22, the spring 122, and the plate spring 222 are provided as the restoring unit provided between the housing unit 21 and arm unit 23, but they are not limited to this. For example, the restoring unit may be an elastic material such as rubber, silicon, or resin. Even if the housing unit 21 and the arm unit 23 are directly connected and the restoring unit is omitted, a certain agitating or other effect can be obtained by the strikes of the striking unit 3.

The housing unit holding the containers 10 and the restoring unit in the first through eleventh embodiments may be applied to the striking units of the twelfth and thirteenth embodiments. That is, any of the embodiments can be selectively combined in the shape of the housing unit, the structure of the restoring unit, and the shape and structure of the striking unit.

In the above embodiment, the mixed object 11, which is two different liquids, is agitated etc. but not limited to this. For example, the agitator can be used during gene transfer (lipofection), during plasmid purification to extract the gene contained in the Escherichia coli, and during disruption of the cell membrane of the Escherichia coli. The agitator can also be used to break up proteins that have been pressed and hardened on the bottom of the microtubes by centrifugation, and can also be used to separate different powders and granules when they are mixed together or vice versa.

In the first embodiment, the rotating unit 32 oscillates and the impactor 31 reciprocates to strike the container 10 from two directions, but not limited to this. For example, the rotating unit 32 may rotate in one direction and the impactor 31 may strike the container 10 from one direction.

In the first embodiment, the oscillation frequency of the impactor 31 is set at 8.9 Hz, but not limited to this. For example, the oscillation frequency can be set to about 2.0 Hz or lower in the case of agitating DNA and reagent in the microtube during the gene transfer. This allows the DNA and the reagent to be agitated as lightly as if the DNA and the reagent are hit with a finger as shown in FIG. 29.

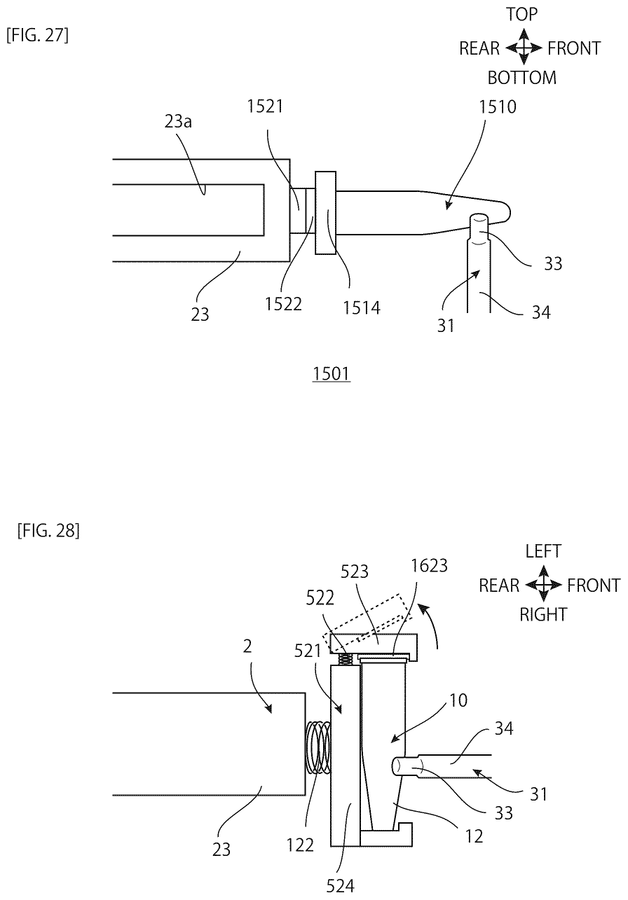

In the first embodiment, the housing unit 21 supports the lid 14 of the container 10 by accommodating therein, but not limited to this. For example, the lid of the container 10 may incorporate therein a magnet. Specifically, as shown in FIG. 27, a container magnet 1522 is integrated into a lid 1514 in an agitator 1501. The container magnet 1522 is in close contact with the magnet 1521 on the arm unit 23. This eliminates the work of housing the lid in the housing unit 21, thus enabling an efficient mass production system when automating the agitator 1501 or incorporating the agitator 1501 into an automated device.

In the sixth embodiment, the container 10 could be attached and detached by the rotation of the movable unit 523 by means of the spring 522 provided in the housing unit 521, but this is not limited to this. For example, as shown in FIG. 28, the container 10 of an agitator 1601 may be sealed by a rubber plate 1623 between the movable unit 523 and the container 10 to prevent liquid leakage, instead of the lid 14. This eliminates the work of attaching and detaching the container 10 to and from the housing unit 21, thereby preventing liquid leakage during transportation of the container 10 by a robot hand or the like and facilitating handling of the container 10 when the agitator device 1601 is automated or incorporated into an automated device. When automating the agitator 1601, the opening and closing of the movable unit 523 may be performed by the robot hand, or an actuator may be incorporated.

In the 15th embodiment, the magnet unit 1421 has the magnets 1422 and the magnet holder 1423, but not limited to this. For example, the magnet unit 1421 may consist only of the magnets 1422 with an abbreviated rectangular cross section. When the impactor 31 strikes the container 10 and the magnets 1422 are separated, one of the sides of the magnets 1422 is in contact. This stabilizes the positional relationship between the housing unit 21 and the arm unit 23. The same effect may be produced by the shape of the yoke, regardless of the shape of the magnet unit 1421, which is composed of the magnet unit 1421 and the yoke.

In the 15th embodiment, the cross section of the magnet unit 1421 is an abbreviated rectangle shape, but not limited to this. For example, the cross section of the magnets may be polygonal. When the magnets are separated from each other, they are in contact with each other on one of the sides, thereby stabilizing the positional relationship between the housing unit 21 and the arm unit 23.

### DESCRIPTION OF SIGNS

1, 101, 201, 301, 401, 501, 601, 701, 801, 901, 1001, 1101, 1201, 1301, 1401 1501 1601 Agitator
2 Support unit
3 Striking unit
4 Driving unit
5 Control unit
6 3-axis table
10 Container
11 Mixed object
12 One end portion
13 Other end portion
14 Lid
21, 321, 421, 521, 621, 721, 821, 921 Housing unit
21A Contact surface
21B Wall
21a Housing space
21c Insertion opening
22 Magnet
23 Arm unit
24 Spring
31, 1131, 1231 Impactor
32 Rotating unit
122 Spring
222 Sheet spring

1. An agitator comprising:
a support unit supporting a container with a mixed object,
a striking unit that continuously strikes the container, and
a driving unit that drives the striking unit,
wherein the container has a one end portion and an other end portion opposite the one end portion,
wherein the support unit supports the one end portion of the container,
wherein the striking unit strikes the other end portion of the container, and
wherein the striking unit is driven by the drive unit to oscillate around an oscillation axis and is capable of striking the other end portion from a first direction and then alternately striking on an oscillation from a second direction different from the first direction.

3. The agitator according to claim 1,
wherein the support unit movably and detachably supports the container,
wherein the agitator further comprises:
an adjusting unit that adjusts a position of the support unit, and
restoring unit provided at a position between the support unit and the adjusting unit and exerting a restoring force on the container to return the container to an original position when the container is moved by a striking of the striking unit.

4. The agitator according to claim 3,
wherein the restoring unit has magnets, and
wherein when the container is struck by the striking unit, at least a part of the magnets is separated from each other, and a magnetic force of the magnets acts on the container as the restoring force for returning the container to the original position.

5. The agitator according to claim 4,
wherein the container has a lid for inserting the mixed object, and
wherein one of the magnets is provided on the support unit and the other magnets is provided on the lid.

6. The agitator according to claim 5,
wherein the restoring unit has a polygonal cross section, and
wherein when the container is struck by the striking unit and at least a part of the magnets is separated, one of polygonal sides of the restoring unit is in contact with each other.

7. The agitator according to claim 21,
wherein the support unit comprises:
a press unit that pushes the container in a pressing direction,
a contact surface that receives the container pushed by the press unit, and
a wall provided to extend from the contact surface to the opposite side of the pressing direction,
wherein the support unit defines a housing space for storing the one end portion and has an insertion opening for storing the one end portion in the housing space, and
wherein the wall forms part of the insertion opening.

9. An agitator comprising:
an outer shell holding a container with a mixed object,
a support unit supporting the outer shell,
a striking unit that continuously strikes the outer shell, and
a driving unit that drives the striking unit,
wherein the striking unit is driven by the drive unit to oscillate around an oscillation axis and is capable of striking the outer shell from a first direction and then alternately striking upon an oscillation from a second direction different from the first direction.

10. An agitation method comprising:
supporting a container with a mixed object, and
striking the container continuously by a striking unit oscillating around an oscillation axis and driven by a driving unit,
wherein the container has a supported one end portion and an other end portion opposite the one end portion, the other end portion being struck by the striking unit, and
wherein the striking unit is capable of striking the other end portion from a first direction and then alternately striking on an oscillation from a second direction different from the first direction.
